(19) United States
(12) Patent Application Publication
(10) Pub. No.: US 2026/0067261 A1
(43) Pub. Date: Mar. 5, 2026

(54) METHOD AND SYSTEM FOR ESTABLISHING NETWORK CONNECTIONS

(71) Applicant: O'PRUEBA TECHNOLOGY INC., Hsinchu City (TW)

(72) Inventors: Yi-Ta Chiang, Hsinchu City (TW); Chun-Hung Hsu, Hsinchu City (TW)

(21) Appl. No.: 19/293,281

(22) Filed: Aug. 7, 2025

(30) Foreign Application Priority Data
Sep. 4, 2024 (TW) 113133539

(51) Int. Cl. H04L 9/40

(52) U.S. Cl. CPC H04L 63/0442

(57) ABSTRACT

A method for establishing network connections includes: monitoring a controller channel by a controller; generating a random peer ID for participating in the controller channel by a customer premise equipment (CPE); discovering the CPE at the controller channel, displaying the CPE on a pending connection list of the controller, and determining whether the CPE should be controlled by the controller; generating a pair of CPE's public key and CPE's private key corresponding to the CPE; transmitting the CPE's public key, the CPE's private key, and a controller's public key corresponding to the controller via the controller channel; deleting the random peer ID, and using the CPE's public key obtained from the controller channel as the CPE's peer ID.

### CROSS-REFERENCE TO RELATED APPLICATION

This non-provisional application claims priority under 35 U.S.C. § 119(a) to Patent Application No. 113133539 filed in Taiwan, R.O.C. on September 4, 2024, the entire contents of which are hereby incorporated by reference.

### BACKGROUND

### Technical Field

The present invention relates to a method and system for establishing network connections, and in particular, to a technique for establishing trusted network connections.

### Related Art

FIG. 1 is a schematic diagram of network connections of a client-server/relay server/virtual private network server and an embodiment of the present invention. Referring to FIG. 1, as shown in FIG. 1, in a conventional client-server network architecture 210, a controller 112 is used as a server, and customer premise equipment (CPE) 122 are each used as a client. The controller 112 is configured with a public IP, each CPE 122 is also configured with a fixed IP, and each CPE 122 is connected to the controller 112 by means of general network connection, for example, TCP/IP. In the client-server network architecture 210, if the CPE 122 or the controller 112 is located behind network address translation (NAT) or located behind a firewall, a connection between the CPE 122 and the controller 112 fails to establish due to the limitations of the network address translation or the barrier of the firewall.

As shown in FIG. 1, in the relay server/virtual private network server network architecture 220, a data center 110 is provided with a cloud controller 113 and a relay server/virtual private network server 224, and a public IP is configured. Each CPE 122 can actively connect to the relay server/virtual private network server 224. Similarly, the controller 112 and the cloud controller 113 can also actively connect to the relay server/virtual private network server 224. In the relay server network architecture 220, a relay server plays an intermediate role in network communication, and when the controller 112 issues an instruction, the instruction will be stored in the relay server first, and the CPE 122 may inquire the relay server whether there is a new instruction to be executed. Since there is a time difference between the controller 112 issuing the instruction to the relay server and the CPE 122 inquiring the relay server whether there is a new instruction, the network latency of the relay server network architecture 220 is relatively high. In the virtual private network server (VPN server) network architecture 220, a virtual encrypted tunnel may be established between the controller 112 and the CPE 122 for communication. Since the virtual private network server requires to perform decryption calculations on a data packet and forward the data packet to a destination address, the network latency of the network architecture of the virtual private network server is relatively high. By means of the intermediate role of the relay server/virtual private network server 224, although the problem that a network connection fails to establish due to the fact that the CPE 122 or the controller 112 is provided behind the network address translation or behind the firewall can be solved, all communications are required to be performed via the relay server/virtual private network server 224, so that the overall communication traffic may be doubled.

Moreover, for the client-server network architecture 210, if the public IP of the controller 112 or the CPE 122 is changed, the public IP needs to be reset to establish the network connection. Similarly, for the relay server/virtual private network server network architecture 220, if the public IP of the relay server/virtual private network server 224 is changed, settings on the controller 112 and the CPE 122 should be changed accordingly to maintain the network connection. In addition, the use of cloud service from the data center 110, for example, Amazon Web Services (AWS), Google Cloud Platform (GCP), may also need to bear the costs of renting a public IP.

As shown in FIG. 1, in a network architecture 230 of an embodiment of the present invention, for example, a libp2p network architecture is utilized. An apparatus participating in a Libp2p network is referred to as a peer, which has a peer ID. In addition to establishing a direct connection with a connection object, the apparatus can assist other network apparatuses in finding connection objects and forward traffic. Libp2p uses a public key in asymmetric encryption as the peer ID, both parties establishing a connection can perform identity authentication and encrypt communication content based on each other's public keys. In this embodiment, each CPE 122 and the controller 112 are each a peer in a P2P network. Therefore, with the peer ID, the CPE 122 and the controller 112 can establish a direct connection. Even if IPs of the CPE 122 and the controller 112 are changed, an object to be connected can also be found with the peer ID. In summary, the network architecture 230 implemented in the embodiment of the present invention has the following advantages: (1) communication traffic consumption due to forward via the relay server/virtual private network server 224 is avoided; (2) the CPE 122 and the controller 112 do not require to use the public IP; and (3) even if the IPs of the CPE 122 and the controller 112 are changed, the connection can be established via the peer ID. Although the libp2p network is taken as an example in this embodiment, it is not intended to limit the present invention, and P2P network architectures that can provide P2P communications, discover peers, establish an encrypted connection, and can perform provisioning and management by means of encrypted connection all fall within the protection scope of the present invention.

FIG. 2 is a schematic diagram of network connections under a firewall of a client-server/relay server/virtual private network server and an embodiment of the present invention. Referring to FIG. 2, as shown in FIG. 2, in a conventional client-server network architecture 310, when the CPE 122 is provided behind a firewall 140, although the CPE 122 can connect to the controller 112 with the public IP, the controller 112 fails to establish a connection with the CPE 122 provided behind the firewall 140.

As shown in FIG. 2, in a relay server/virtual private network server network architecture 320, when the CPE 122 is provided behind the firewall 140 or the controller 112 is provided behind the firewall 140, the CPE 122 can actively and unidirectionally establish a connection with the relay server/virtual private network server 224. Similarly, the controller 112 can also actively and unidirectionally establish a connection with the relay server/virtual private network server 224. Therefore, even if the CPE 122 and the controller 112 are provided behind the firewall 140, the connection between the CPE 122 and the controller 112 can still be established by means of the relay server/virtual private network server 224. However, the communication traffic may be doubled. Moreover, since the connection between the CPE 122 and the controller 112 is established by means of the relay server/virtual private network server 224, once any connection is interrupted, the CPE 122 or the controller 112 cannot resume the connection therebetween until the connection between a connection object and the relay server/virtual private network server 224 is established again.

As shown in FIG. 2, in the network architecture 330 of an embodiment of the present invention, when the CPE 122 is provided behind the firewall 140 or the controller 112 is provided behind the firewall 140, the CPE 122 and the controller 112 can establish a bidirectional direct connection via the libp2p network architecture (as shown in the data stream direction illustrated in FIG. 2). In this embodiment, when the CPE 122 is to establish a connection with the controller 112, the connection can be established first via a bootstrap peer 142, or an object to be connected can be discovered by means of network discovery mechanism. The network discovery mechanism is, for example, a multicast domain name system (mDNS), a distributed hash table (DHT), or a direct connection upgrade through relay (DCUtR). A mutually trusted connection is established by the method for establishing network connections. In this embodiment, the CPE 122 transfers a connection request to the controller 112, after receiving the connection request, the controller 112 can determine whether to agree on the connection request according to the CPE 122, and if the controller 112 agrees on the connection request, a pair of public and private keys corresponding to the CPE 122 can be generated for the CPE 122 to establish the mutually trusted direct connection. In this embodiment, the method for establishing network connections can be roughly divided into three stages: discovery, provisioning, and management. An objective of the discovery stage is to establish a direct connection between the CPE 122 and the controller 112 by means of network discovery mechanism. An objective of the provisioning stage is to establish an encrypted connection between the CPE 122 and the controller 112, and initialize various settings of the CPE 122, such as initialize the settings of the SSID name and password of the CPE 122. An objective of the management stage is to transmit requirements and responses of a representational state transfer application programming interface (Rest API) by means of the encrypted connection. In this embodiment, even with the firewall 140 as a barrier, the encrypted connection can be established between the CPE 122 and the controller 112 under the condition that both the CPE 122 and the controller 112 agree to connect, and the controller 112 can achieve the function of remotely provisioning and managing the CPE 122 across a network.

### SUMMARY

In view of this, an embodiment of the present invention provides a method for establishing network connections, which is applicable in a local-area network and includes: sending machine information via multicast by means of customer premise equipment (CPE); monitoring a CPE's participating request at a multicast address, displaying the CPE on a pending connection list of a controller, and determining whether the CPE should be controlled by the controller; generating a pair of CPE's public key and CPE's private key corresponding to the CPE, and recording the CPE's public key in the controller; and transmitting the CPE's public key, the CPE's private key, and a controller's public key corresponding to the controller via TCP/IP.

An embodiment of the present invention provides a method for establishing network connections, which includes: monitoring a controller channel by a controller; generating a random peer ID for participating in the controller channel by a CPE; informing a user of a controller channel key by a controller manager; inputting the controller channel key by the user; discovering the CPE at the controller channel by the controller, displaying the CPE on a pending connection list of the controller, and determining whether the CPE should be controlled by the controller; generating a pair of CPE's public key and CPE's private key corresponding to the CPE by the controller; transmitting the CPE's public key, the CPE's private key, and a controller's public key corresponding to the controller via the controller channel by the controller; deleting the random peer ID by the CPE, and using the CPE's public key obtained from the controller channel as the peer ID corresponding to the CPE.

An embodiment of the present invention provides a method for establishing network connections, which includes: encrypting a connection request with the CPE's private key and the controller's public key, and connecting to the controller via a peer; authenticating the connection request according to the controller's public key and forwarding the connection request from the CPE; running network address translation (NAT) hole punching to authenticate the CPE's public key and returning connection information; establishing an encrypted connection between the CPE and the controller; and transmitting requirements and responses of a Rest API by means of the encrypted connection.

An embodiment of the present invention provides a system for establishing network connections, which includes: a data center, the data center is provided with a firewall and a controller; at least one local-area network, each local-area network is provided with a firewall and a CPE; and a bootstrap peer, the bootstrap peer has connection information of a terminal device and the controller, and establishes a connection with the terminal device and the controller, respectively, where the controller and the CPE establish a direct connection between the terminal device and the controller in an Internet by using a method for establishing network connections.

### BRIEF DESCRIPTION OF THE DRAWINGS

FIG. 1 is a schematic diagram of network connections of a client-server/relay server/virtual private network server and an embodiment of the present invention.

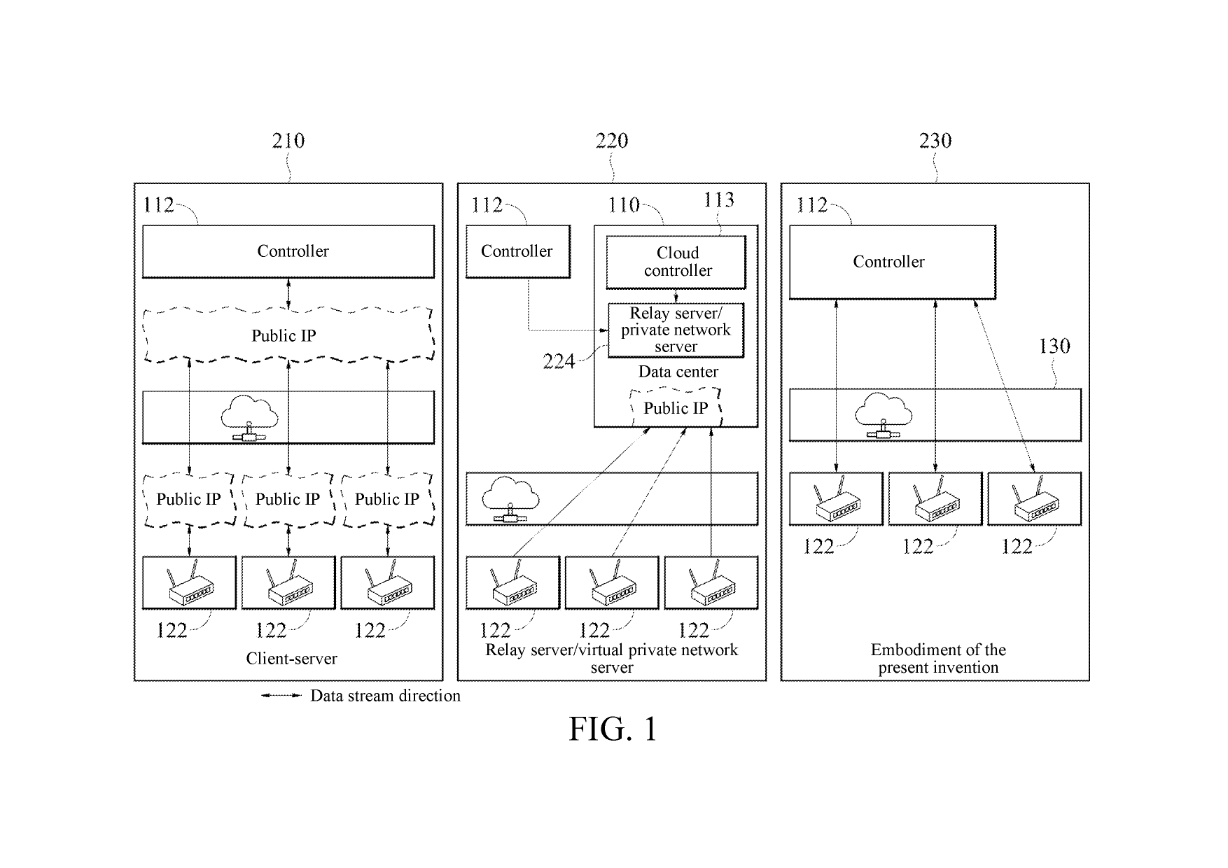

FIG. 2 is a schematic diagram of network connections under a firewall of a client-server/relay server/virtual private network server and an embodiment of the present invention.

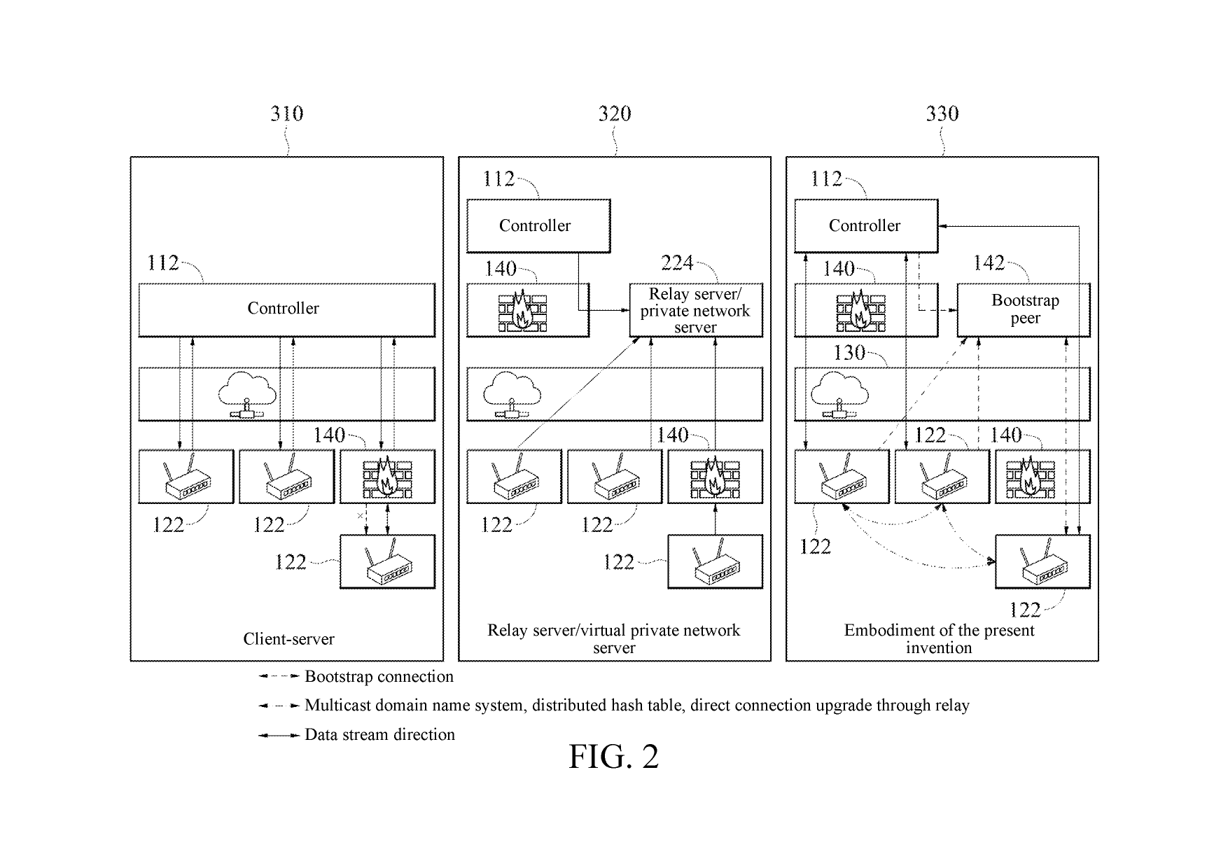

FIG. 3 is a network architecture diagram of a system for establishing network connections illustrated according to an embodiment of the present invention.

FIG. 4 is a flowchart of a method for establishing network connections illustrated according to an embodiment of the present invention.

FIG. 5 is a flowchart of a method for establishing network connections illustrated according to an embodiment of the present invention.

FIG. 6 is a flowchart of a method for establishing network connections illustrated according to an embodiment of the present invention.

FIG. 7 is a schematic diagram of requirements and responses of a Rest API of a method for establishing network connections illustrated according to an embodiment of the present invention.

FIG. 8 is a schematic diagram of a connection through a firewall illustrated according to an embodiment of the present invention.

FIG. 9 is a schematic diagram of a connection through a firewall illustrated according to an embodiment of the present invention.

FIG. 10 is a schematic diagram of a connection through a firewall illustrated according to an embodiment of the present invention.

FIG. 11 is a schematic diagram of a connection through a firewall illustrated according to an embodiment of the present invention.

FIG. 12 is a schematic diagram of a connection through a firewall illustrated according to an embodiment of the present invention.

### DETAILED DESCRIPTION

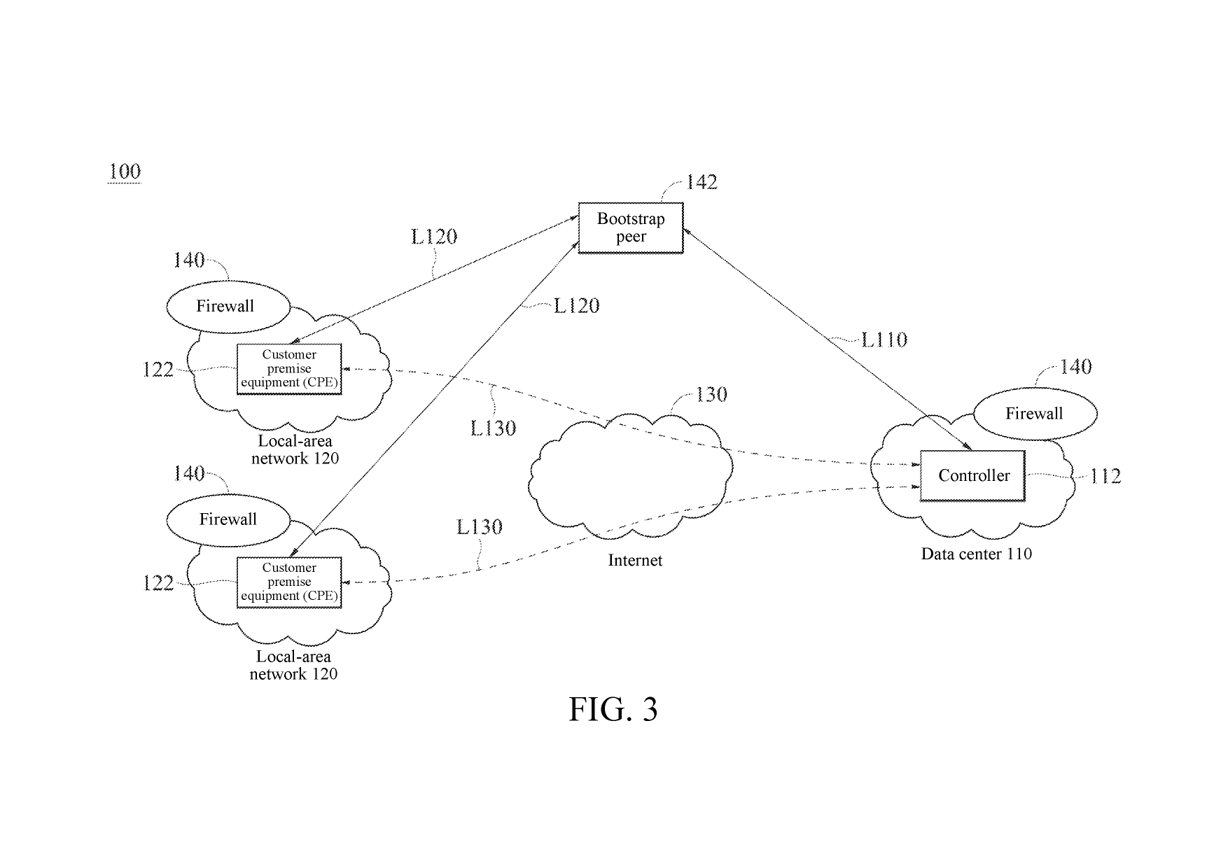

FIG. 3 is a network architecture diagram of a system for establishing network connections illustrated according to an embodiment of the present invention. Referring to FIG. 3, in an embodiment illustrated in FIG. 3, a network architecture 100 of a system for establishing network connections includes a data center 110, at least one local-area network 120, an Internet 130 and a bootstrap peer 142. The data center 110 is provided with a firewall 140 and a controller 112. Each local-area network 120 is provided with a firewall 140 and a customer premise equipment (CPE) 122. The bootstrap peer 142 is a known peer in a P2P network, and records connection information of other peers, for example, connection information of the controller 112 and connection information of the CPE 122. The connection information includes IP and a port. In an embodiment, the bootstrap peer 142 may be a piece of small software, and is configured with a public IP, thereby facilitating peers in the P2P network to find the bootstrap peer 142 and obtain the connection information of other peers from the bootstrap peer 142. In an embodiment, the CPE 122 can establish a connection L120 with the bootstrap peer 142 and obtain the connection information of the controller 112 from the bootstrap peer 142, and even if the network topology changes, for example, the controller 112 changes the IP address and the port, the latest connection information of the controller 112 can be updated by means of the bootstrap peer 142, so that the CPE 122 can establish a connection with the controller 112. Similarly, the controller 112 can establish a connection L110 with the bootstrap peer 142 and obtain the connection information of the CPE 122 from the bootstrap peer 142. Moreover, in the system for establishing network connections, a method for establishing network connections is included. In an embodiment, after the CPE 122 obtains the connection information of the controller 112 from bootstrap peer 142, by means of the method for establishing network connections, the CPE 122 and the controller 112 can establish a direct connection L130 in the Internet 130 to carry out P2P direct communication, thereby saving communication traffic. In this case, the task of the bootstrap peer 142 to assist with network discovery and connection is completed.

The CPE 122 of the local-area network 120, for example, routers, modems, switches, and other network devices, are usually provided inside the firewall 140 and protect against unauthorized access and attacks by the firewall 140. Due to the firewall 140 serving as a barrier in the local-area network 120, the controller 112 fails to establish a direct connection with the CPE 122. Similarly, the firewall 140 in the data center 110 may also cause the CPE 122 to fail to establish a direct connection with the controller 112. In addition, the CPE 122 and the controller 112 may also be provided behind network address translation, and the controller 112 may fail to establish a direct connection with the CPE 122 due to the limitation of the network address translation. In the network architecture 100 of the system for establishing network connections in this embodiment, the controller 112 plays a role of managing and coordinating network devices and resources, and the controller may be a piece of software which is provided on a network device. By establishing a direct connection between the controller 112 and the CPE 122, the controller 112 can control and manage the CPE 122, for example, setting basic parameters for the CPE 122 or pushing and updating the latest software or firmware version.

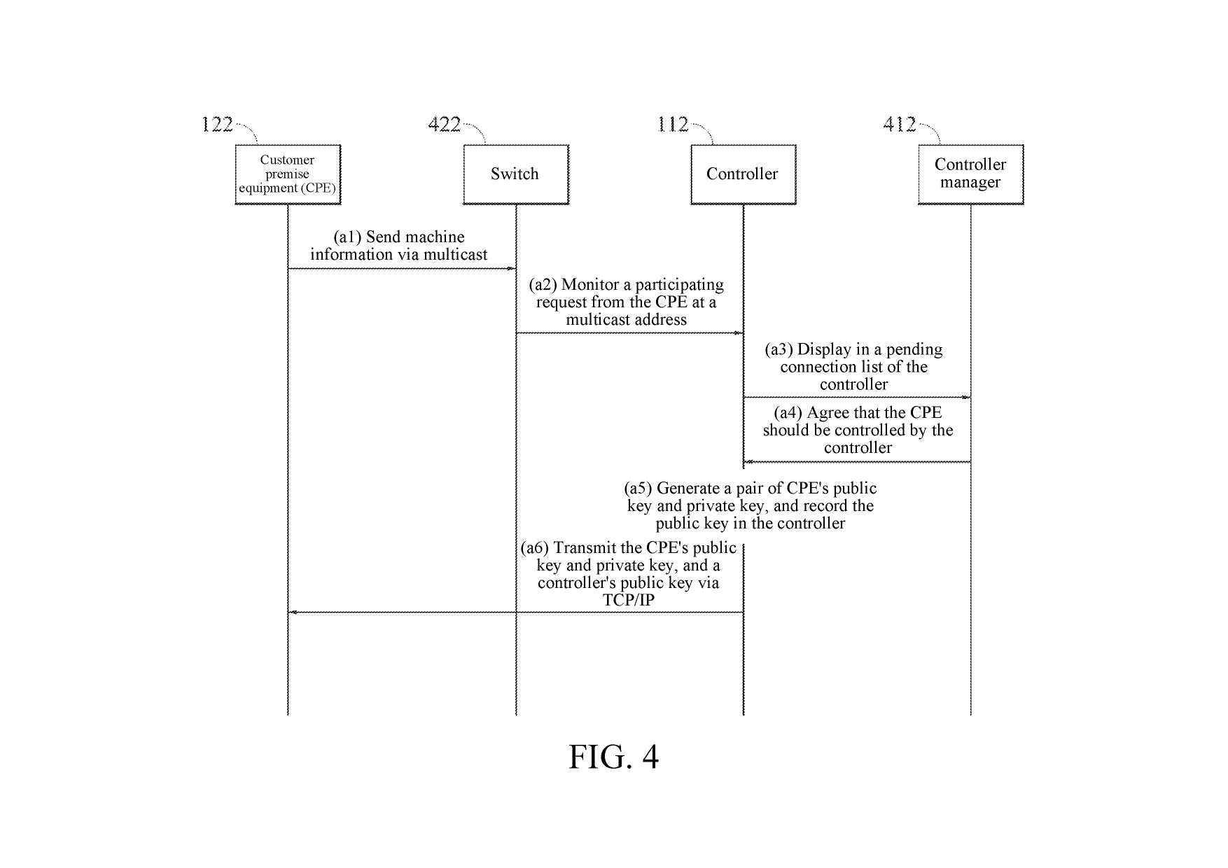

FIG. 4 is a flowchart of a method for establishing network connections illustrated according to an embodiment of the present invention. Referring to FIG. 4, in an embodiment illustrated in FIG. 4, the method for establishing network connections is suitable for a discovery stage, especially network discovery in the local-area network 120. In this embodiment, the local-area network 120 includes a CPE 122, a switch 422, a controller 112, and a controller manager 412. A network device in the local-area network 120 is connected via the switch 422. When a new CPE 122 desires to connect to the controller 112 and is controlled by the controller 112, the method for establishing network connections in this embodiment includes the following steps: (a1) send machine information via multicast by the CPE 122. In an embodiment, the CPE 122 makes a connection request via multicast with a multicast address within a range of the local-area network 120 for which the switch 422 is responsible, and requires the controller 112 in the local-area network 120 to add the information of the CPE 122 to a direct connection list of the controller 112, with the purpose of allowing the controller 112 to record and manage the CPE 122. (a2) Monitor a participating request from the CPE 122 at the multicast address. In an embodiment, the benefit of using multicast over broadcast is that communication packets may not be sent to all the CPEs 122 in the local-area network 120, and only the CPE 122 or the controller 112 monitoring the multicast address can receive the communication packets, so that not too much network traffic may be consumed. Additionally, since unicast requires manually specifying the IP of a connection object, the CPE 122 fails to know the IP of the controller 112 at first, the connection request cannot be sent to the controller 112 via unicast. (a3) Display the CPE 122 in a pending connection list of the controller 112. In an embodiment, the machine information of the CPE 122 is displayed in the pending connection list via a user interface of the controller 112. (a4) Determine whether the CPE 122 should be controlled by the controller. In an embodiment, the controller manager 412 reviews the machine information of the CPE 122 in the pending connection list to determine whether to allow the CPE 122 to be controlled by controller 112. After it is agreed that the CPE 122 should be controlled by the controller 112, a next step may be performed. That is, a connection can only be established between the CPE 122 and the controller 112 upon mutual agreement. (a5) Generate a pair of CPE 122's public key and CPE 122's private key corresponding to the CPE 122, and recording the CPE 122's public key in the controller 112. In an embodiment, when the controller manager 412 agrees that the CPE 122 is controlled by the controller 112, the controller 112 uses a public key cryptographic function library to generate a pair of public/private keys for the CPE 122, i.e., the CPE 122's public key and the CPE 122's private key, where the CPE 122's public key represents the peer ID corresponding to the CPE 122. The controller 112 records the CPE 122's public key for subsequent authentication of the CPE 122 and decryption of communication contents between the controller and the CPE 122. (a6) Transmit the CPE 122's public key, the CPE 122's private key, and a controller 112's public key corresponding to the controller 112 via TCP/IP. In an embodiment, under the condition that the local-area network 120 has relatively no network security concerns, the controller 112 transmits the CPE 122's public key, the CPE 122's private key, and the controller 112's public key corresponding to the controller 112 to the CPE 122 via TCP/IP, where the controller 112's public key represents the peer ID corresponding to the controller 112. Certainly, in another embodiment, the controller 112 may encrypt the CPE 122's public key, the CPE 122's private key and the controller 112's public key corresponding to the controller 112 first, and then transmit them to the CPE 122 via TCP/IP. In this case, both the CPE 122 and the controller 112 know each other's public keys (i.e., the peer ID), and can authenticate each other with the peer IDs.

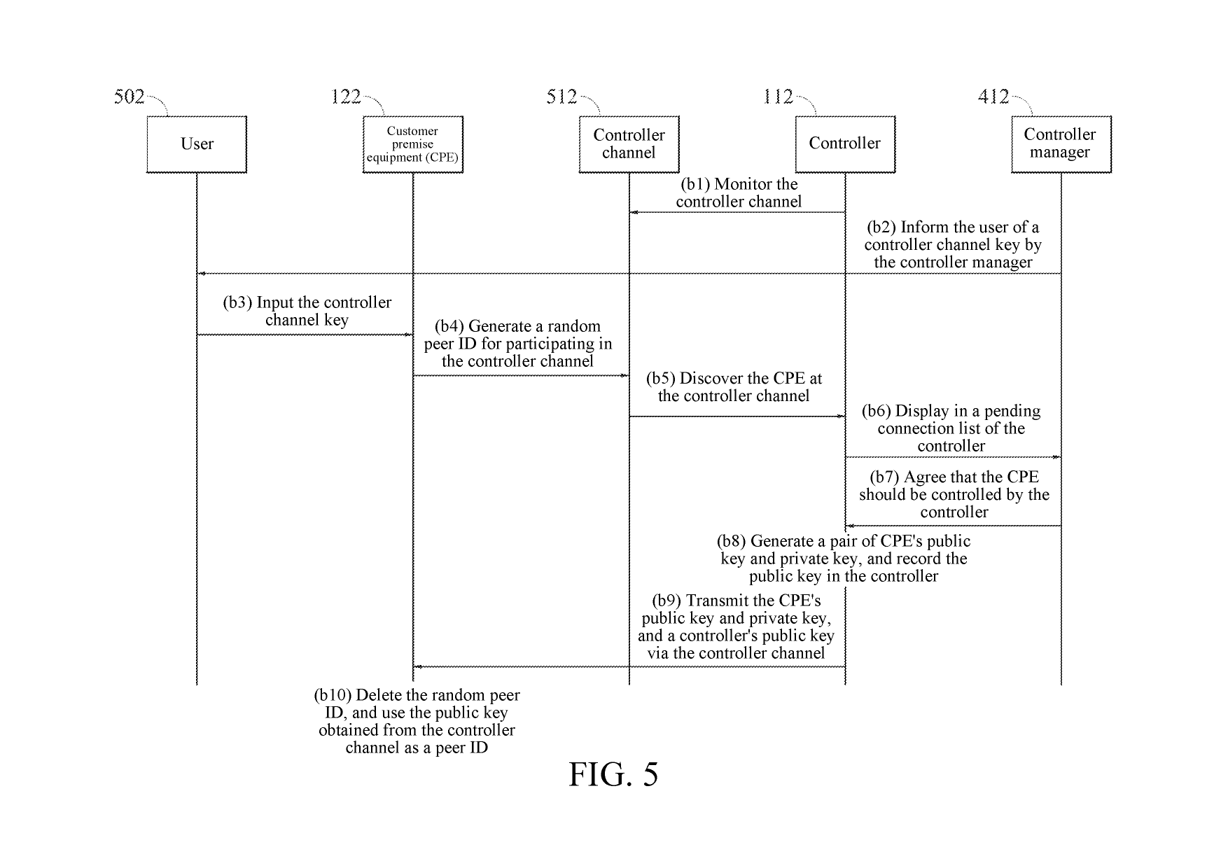

FIG. 5 is a flowchart of a method for establishing network connections illustrated according to an embodiment of the present invention. Referring to FIG. 5, in an embodiment illustrated in FIG. 5, the method for establishing network connections is suitable for the discovery stage, especially network discovery in a cross-regional network. In this embodiment, the cross-regional network includes a user 502, a CPE 122, a controller channel 512, a controller 112, and a controller manager 412. A network device in the cross-regional network can communicate in the controller channel 512. When a new CPE 122 desires to connect to the controller 112 and is controlled by the controller 112, the method for establishing network connections in this embodiment includes the following steps: (b1) monitor the controller channel 512 by the controller 112. In an embodiment, the controller 112 monitors the controller channel 512 controlled by the controller to detect activities in the network, thereby knowing that any new CPE 122 has sent a connection request to participate in a direct connection list of the controller 112. (b2) Inform the user 502 of a controller channel key by the controller manager 412. In an embodiment, the controller channel key is generated by the controller 112, and it is necessary to obtain the controller channel key to participate in the controller channel 512. The user 502 can obtain the controller channel key from a user interface of the controller 112, or the user 502 can also obtain the controller channel key from the controller manager 412 via other encrypted channels or pipelines. (b3) Input the controller channel key. In an embodiment, the user 502 inputs the controller channel key via the user interface of the controller 112. (b4) Generate a random peer ID for participating in the controller channel 512 by the CPE 122. In an embodiment, the CPE 122 randomly generates a pair of public key and private key via a public key cryptographic function library, and uses the public key generated by the CPE 122 as the random peer ID, and the CPE 122 uses the random peer ID to participate in the controller channel 512. In this case, other peers may help forward the connection request sent by the CPE 122 in the controller channel 512, where the content of the connection request includes information such as serial number, version, IP and port of the CPE 122, for example, information encoded in JSON {"SerialNumber": "xxx", "Version":"1.4", "IP":"192.168.10.20"}. (b5) Discover the CPE 122 at the controller channel 512. In an embodiment, the controller 112 obtains the connection request from the CPE 122 via other peers in the controller channel 512. (b6) Display the information of the CPE 122 in a pending connection list of the controller 112. In an embodiment, the content of the connection request transmitted by the CPE 122 in the controller channel is displayed via the user interface of the controller 112. (b7) Determine whether the CPE 122 should be controlled by the controller. In an embodiment, the controller manager 412 reviews the pending connection list via the user interface of the controller 112 to determine whether to allow the CPE 122 to be controlled by the controller 112. That is, the controller manager 412 can determine whether the CPE 122 should be controlled by the controller 112 according to the content of the connection request transmitted by the CPE 122 in the controller channel 512. (b8) Generate a pair of CPE 122's public key and CPE 122's private key corresponding to the CPE 122. In an embodiment, if the CPE 122 is allowed to be controlled by the controller, the controller 112 uses the public key cryptographic function library to generate the CPE 122's public key and the CPE 122's private key for the CPE 122, where the CPE 122's public key represents the peer ID corresponding to the CPE 122. For example, the peer ID corresponding to the CPE 122 can be obtained by making a hash calculation on the CPE 122's public key. The controller 112 records the CPE 122's public key for subsequent authentication of the CPE 122 and decryption of the communication content between the controller and the CPE 122. (b9) Transmit the CPE 122's public key, the CPE 122's private key, and a controller 112's public key corresponding to the controller 112 via the controller channel 512. In an embodiment, the controller 112 transmits the public key corresponding to the CPE 122 and the CPE 122's private key, and the controller 112's public key corresponding to the controller 112 via the controller channel 512, where the controller 112's public key represents the peer ID corresponding to the controller 112. For example, a controller 112's peer ID can be obtained by making a hash calculation on the controller 112's public key. (b10) Delete the random peer ID, and use the CPE 122's public key obtained from the controller channel 512 as a CPE 122's peer ID. In an embodiment, before the CPE 122 obtains the CPE 122's public key (peer ID) issued by the controller 112, the random peer ID generated by the CPE 122 is only used for temporary communication. When the CPE 122 obtains the CPE 122's public key issued by the controller 112, the random peer ID can be deleted, and the CPE 122's public key issued by the controller 112 is used as the peer ID. In terms of network security management, since the CPE 122 and the controller 112 know each other's public keys, they can authenticate each other's identities with the CPE 122's peer ID and the controller 112's peer ID, thereby establishing a mutually trusted direct connection.

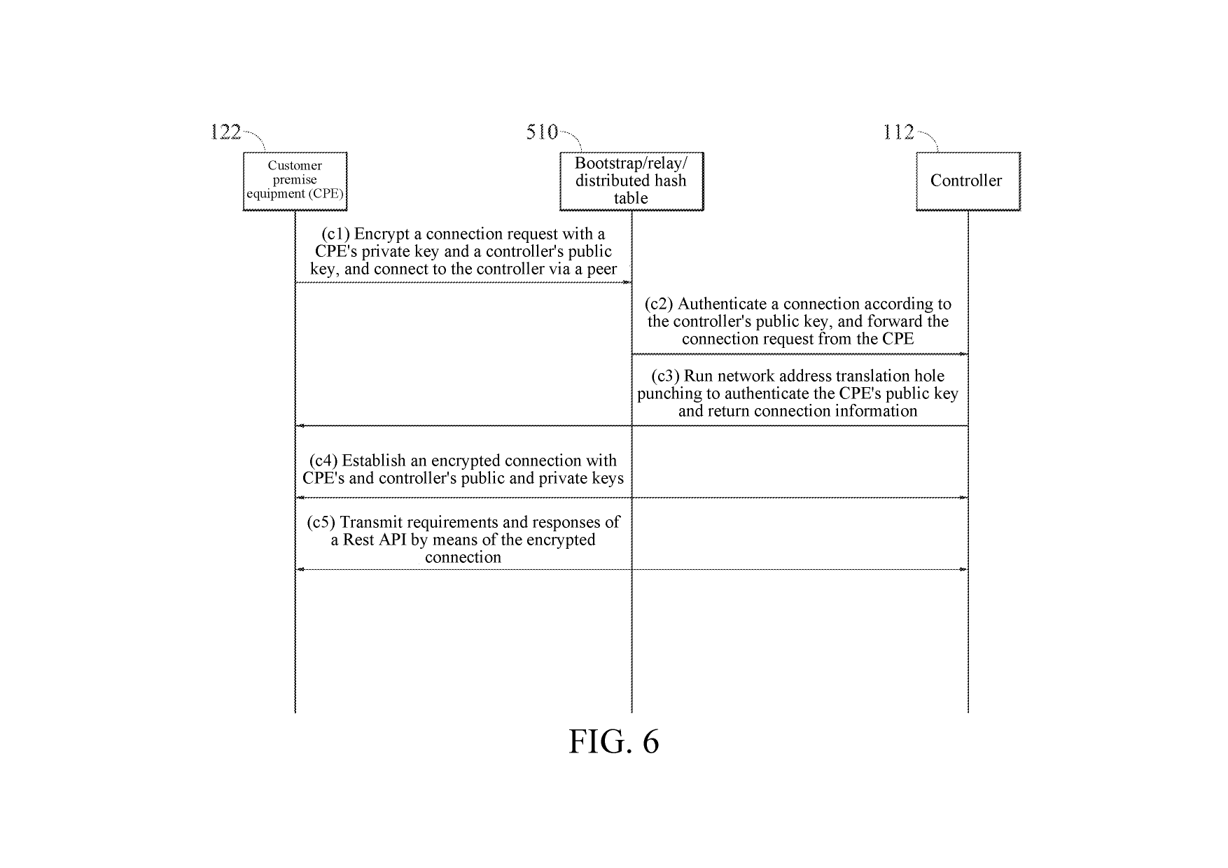

FIG. 6 is a flowchart of a method for establishing network connections illustrated according to an embodiment of the present invention. Referring to FIG. 6, in an embodiment illustrated in FIG. 6, the method for establishing network connections is suitable for provisioning and management stages. In this embodiment, the cross-regional network includes a CPE 122, a bootstrap/relay/distributed hash table 510 and a controller 112. The method for establishing network connections in this embodiment includes the following steps: (c1) encrypt a connection request with a CPE 122's private key and a controller 112's public key, and connect to the controller 112 via a peer. In an embodiment, the CPE 122 is allowed to connect to the controller 112 using the CPE 122's peer ID via the peer of the bootstrap/relay/distributed hash table 510 (a bootstrap peer, a relay peer, or a peer corresponding to the distributed hash table). (c2) Authenticate a connection according to the controller 112's public key, and forward the connection request from the CPE 122. (c3) Run network address translation (NAT) hole punching to authenticate the CPE 122's public key and return connection information. In an embodiment, AutoNAT is used for determining whether there is a firewall 140 or network address translation as a barrier between the CPE 122 and the controller 112. If there is a barrier, the controller 112 uses the technique of NAT hole punching to establish a direct connection, for example, via DCUtR, and if the connection cannot be established, the connection information of the controller 112 is forwarded with a relay to reduce the consumption of network resources. (c4) Establish an encrypted connection with CPE 122's and controller 112's public and private keys. In an embodiment, the encrypted connection between the CPE 122 and the controller 112 can be achieved via a public key cryptographic function library. (c5) Transmit requirements and responses of a Rest API by means of the encrypted connection. In an embodiment, after the encrypted connection is established between the CPE 122 and the controller 112, the controller 112 can issue an instruction via the Rest API to the CPE 122 to remotely control and manage the CPE 122.

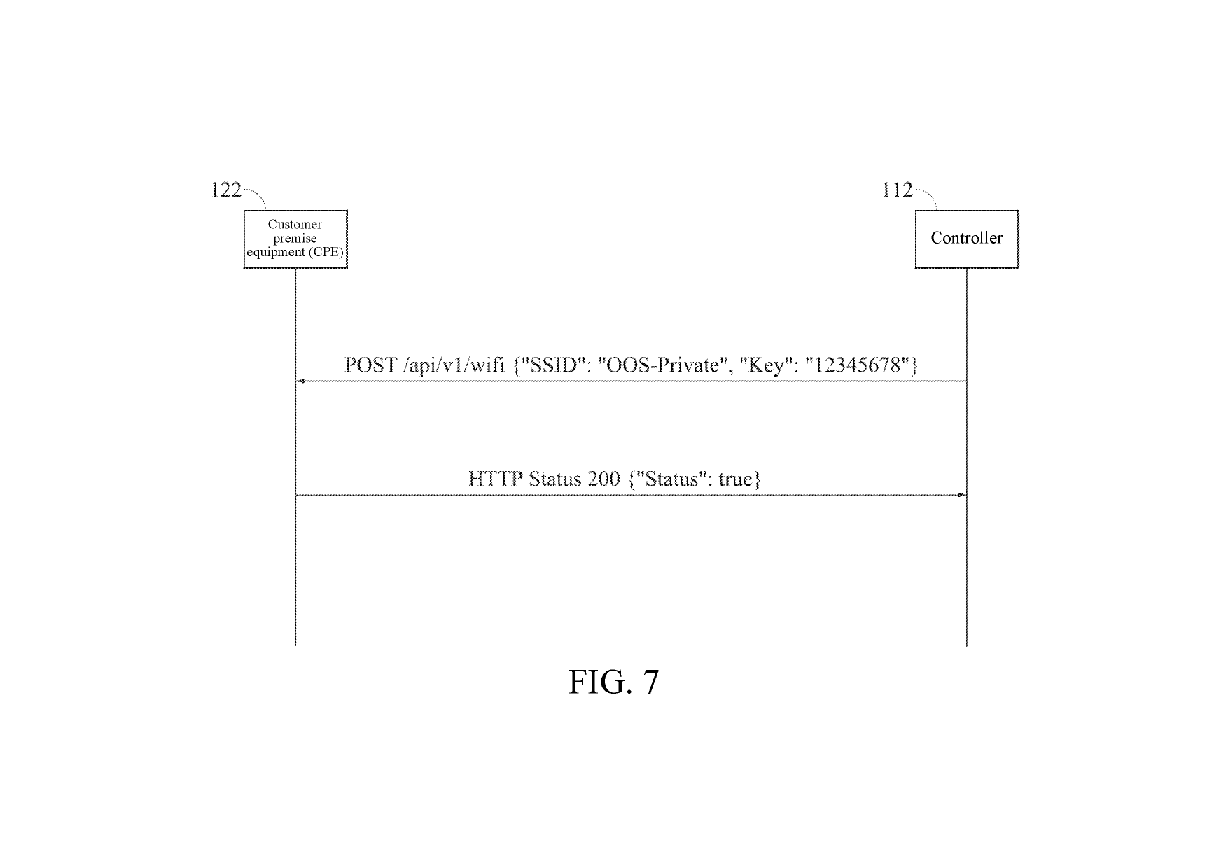

FIG. 7 is a schematic diagram of requirements and responses of a Rest API of a method for establishing network connections illustrated according to an embodiment of the present invention. Referring to FIG. 7, in an embodiment illustrated in FIG. 7, when the CPE 122 establishes an encrypted connection with the controller 112, the controller 112 issues an instruction via Rest API to change SSID and Key set on the CPE 122. For example: POST /api/v1/wifi {"SSID": "OOS-Private", "Key": "12345678"}. Afterwards, the CPE 122 responds to an HTTP status code 200, representing that a request from the Rest API has been successfully handled. For example: HTTP Status 200 {"Status": true}.

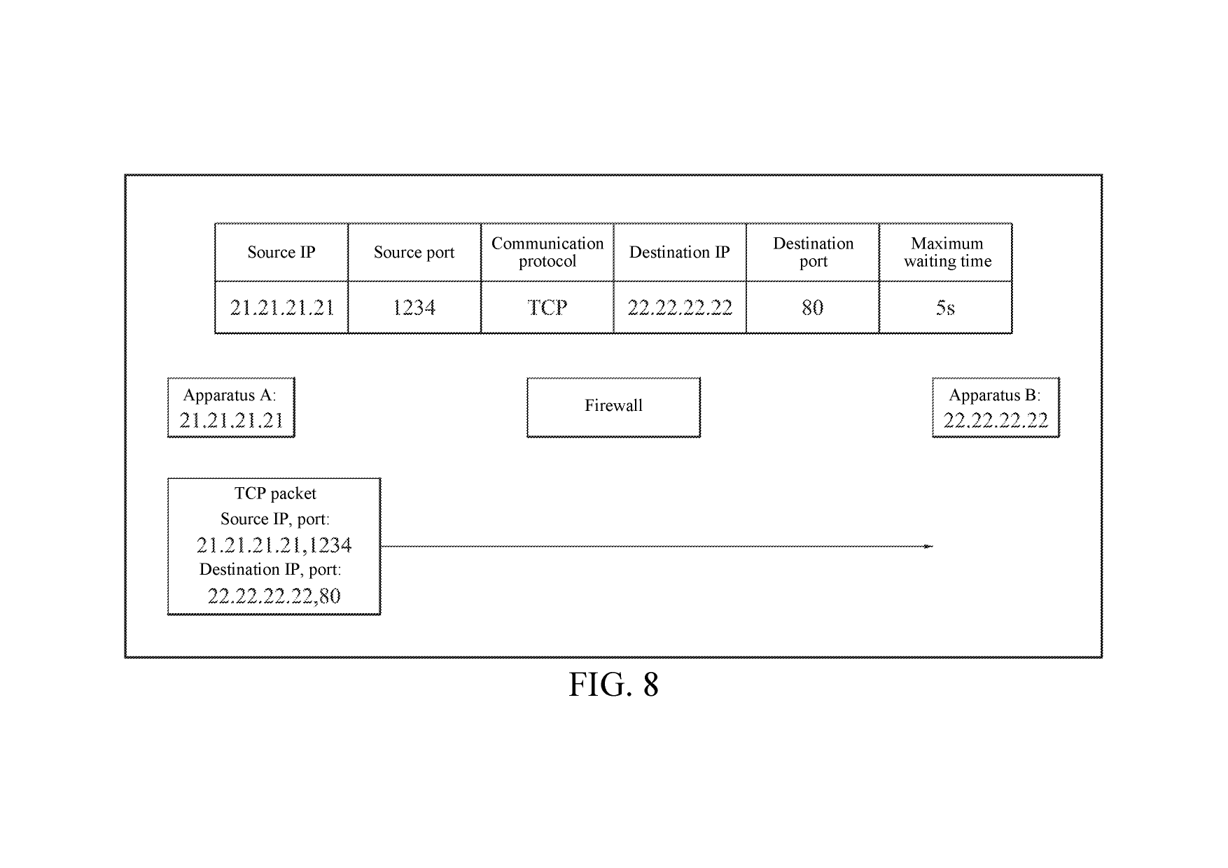

FIG. 8 is a schematic diagram of a connection through a firewall illustrated according to an embodiment of the present invention. Referring to FIG. 8, in an embodiment illustrated in FIG. 8, how a firewall records connection pass-through information may be illustrated. As shown in FIG. 8, when an internal apparatus, such as an apparatus A, desires to transmit a TCP packet via the firewall to establish a connection with an external apparatus B, the firewall may not only modify the source IP and source port of the TCP packet due to network address translation, but also record the connection pass-through information, that is, the connection pass-through information (source IP, source port, communication protocol, destination IP, destination port) that is allowed to pass is recorded to allow the subsequent responses of the apparatus B to pass.

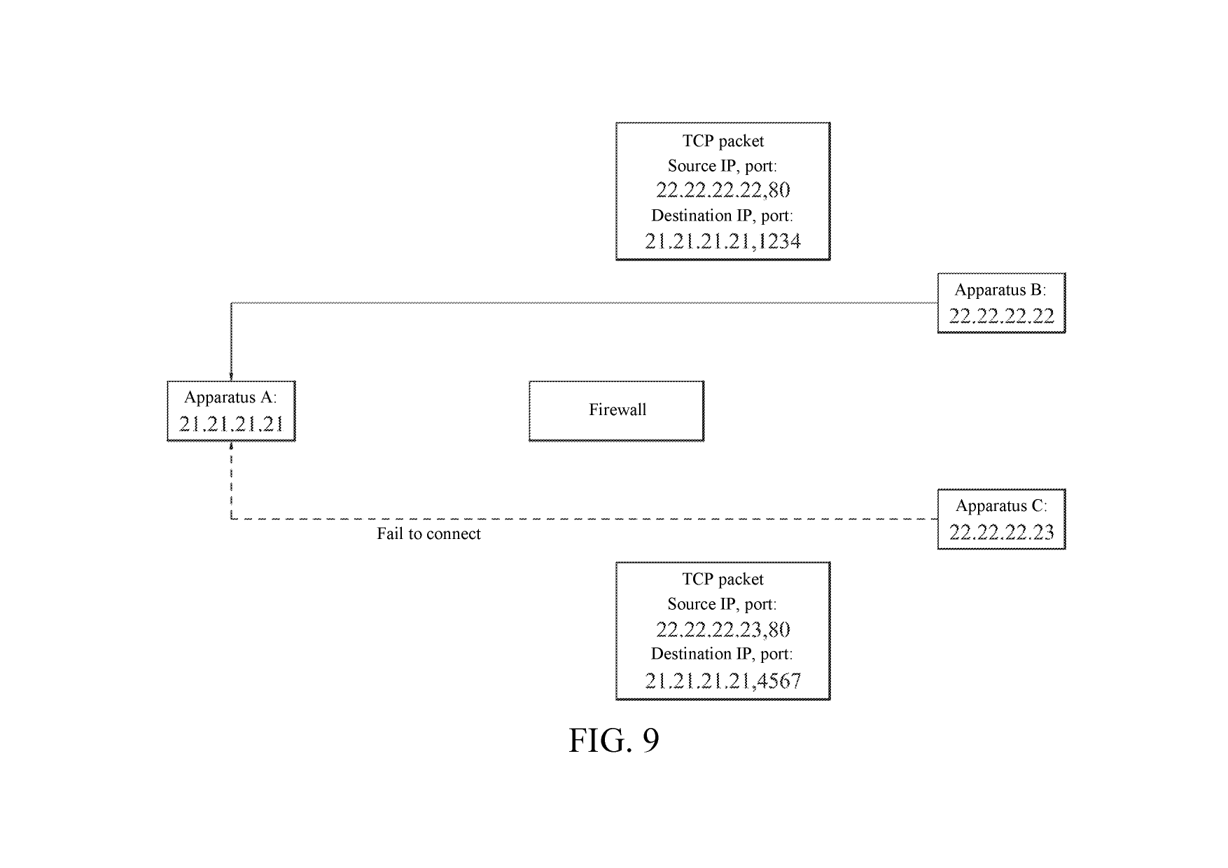

FIG. 9 is a schematic diagram of a connection through a firewall illustrated according to an embodiment of the present invention. Referring to both FIG. 8 and FIG. 9, in an embodiment illustrated in FIG. 9, how the TCP response packet passes through the firewall may be illustrated. As shown in FIG. 9, when the apparatus B transmits a TCP response packet back, the firewall has already recorded related connection pass-through information and thus knows that this connection was initiated by the apparatus A, and thus, the connection of the apparatus B may be allowed to pass. However, when an external apparatus, for example, an apparatus C, transmits a TCP response packet back, since the firewall has not recorded the related connection pass-through information, the firewall fails to know which internal apparatus initiated this connection, and thus, the connection of the apparatus C may not be allowed to pass. To sum up, when the response packet of the external apparatus passes through the firewall, the firewall only allows a packet already in the connection pass-through information to pass.

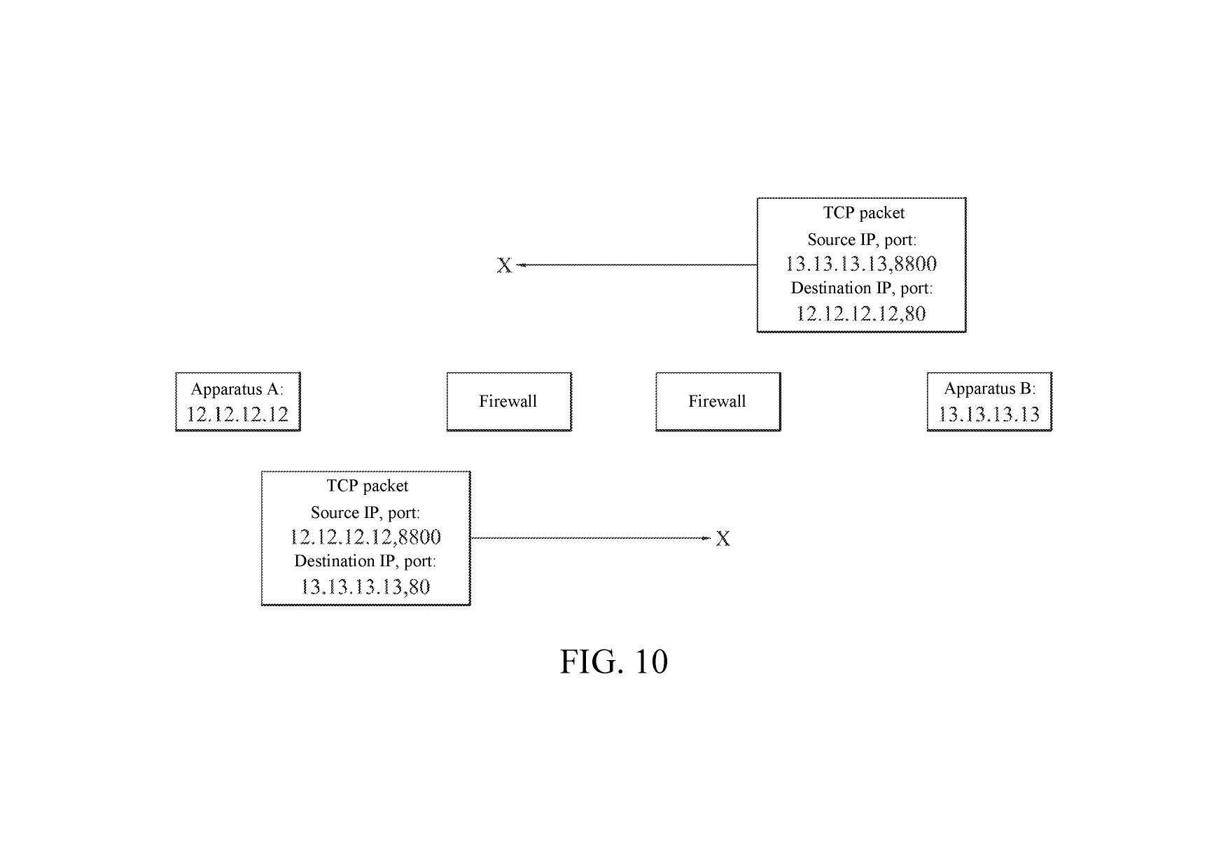

FIG. 10 is a schematic diagram of a connection through a firewall illustrated according to an embodiment of the present invention. Referring to FIG. 10, in an embodiment illustrated in FIG. 10, the connection situation of a scenario where there is a firewall in a network environment of the apparatus A and there is also a firewall in a network environment of the apparatus B is illustrated. As shown in FIG. 10, since the firewall of the apparatus B does not record the related connection pass-through information, the TCP packet of the apparatus A may be blocked by the firewall of the apparatus B. Similarly, since the firewall of the apparatus A does not record the related connection pass-through information, the TCP packet of the apparatus B may be blocked by the firewall of the apparatus A. Therefore, neither party can pass through the firewall to connect to the other.

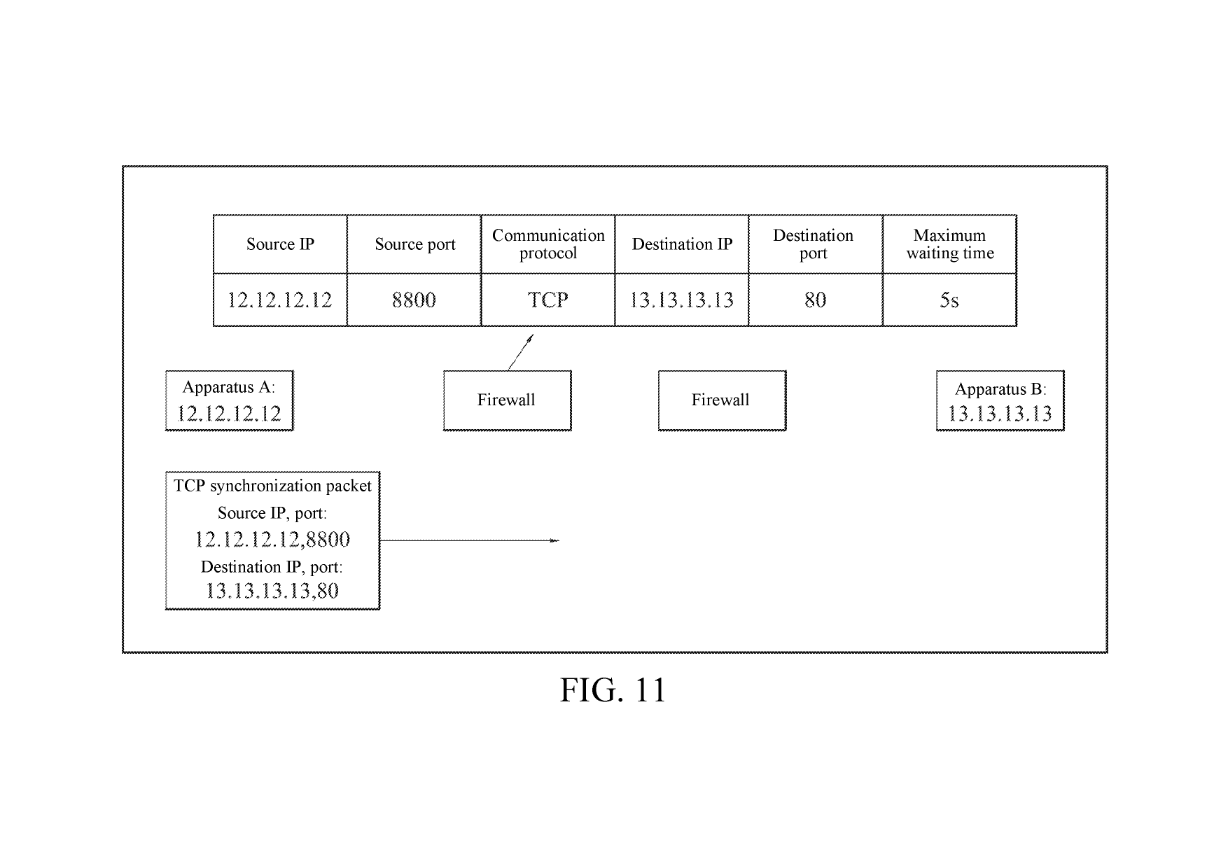

FIG. 11 is a schematic diagram of a connection through a firewall illustrated according to an embodiment of the present invention. Referring to FIG. 11, in an embodiment illustrated in FIG. 11, how to simulate a connection request via a TCP synchronization packet in a scenario where there are firewalls on both sides may be illustrated. First, it is determined that the apparatus A and the apparatus B are synchronous in system time, and the apparatus A and the apparatus B have established a connection via a relay at first, and a time delay from the apparatus A to the apparatus B is measured. As shown in FIG. 11, to enable the TCP response packet of the apparatus B to pass through the firewall of the apparatus A, the apparatus A spoofs a TCP synchronization packet to the apparatus B, and requires the firewall of the apparatus A to record the connection pass-through information, so that the firewall can identify the response packet of the apparatus B. Similarly, to enable the TCP response packet of the apparatus A to pass through the firewall of the apparatus B, the apparatus B spoofs a TCP synchronization packet to the apparatus A, and requires the firewall of the apparatus B to record the connection pass-through information, so that the firewall can identify the response packet of the apparatus A.

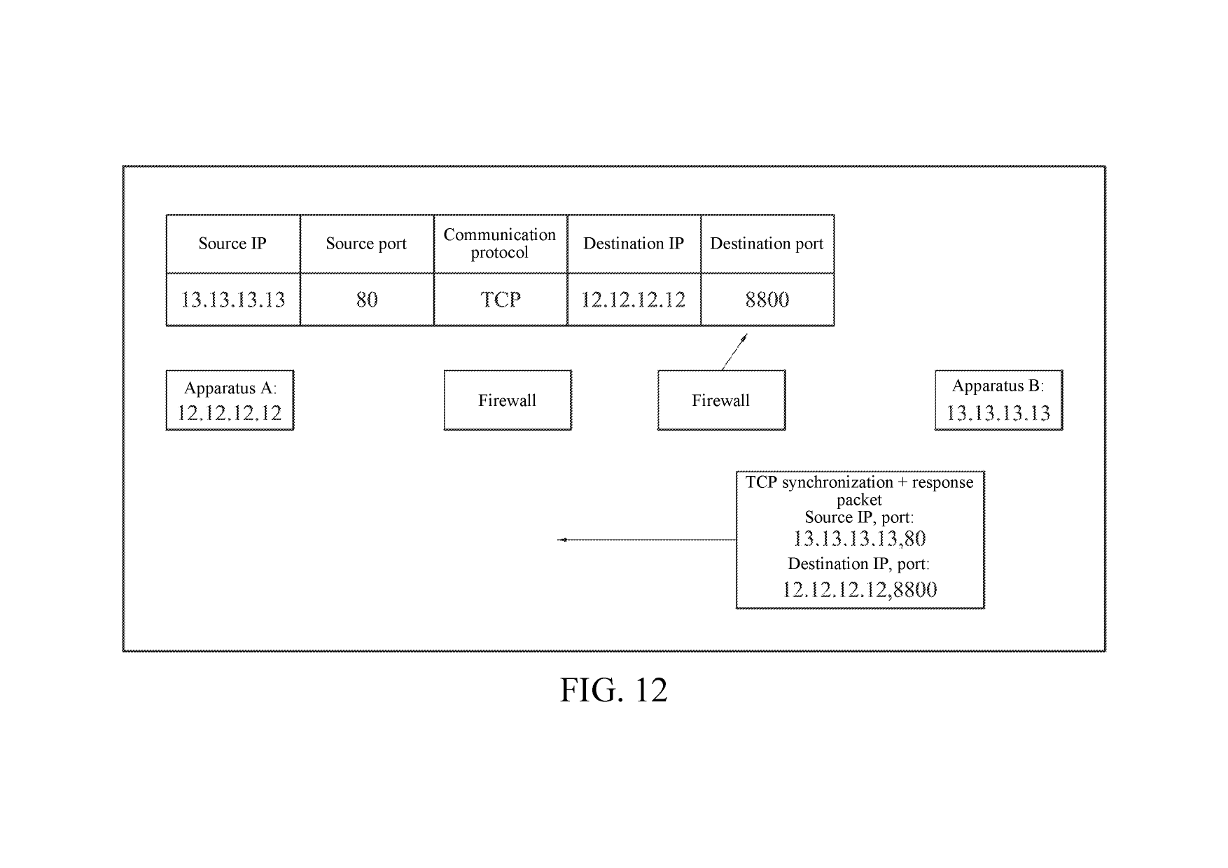

FIG. 12 is a schematic diagram of a connection through a firewall illustrated according to an embodiment of the present invention. Referring to both FIG. 11 and FIG. 12, in an embodiment illustrated in FIG. 12, how TCP synchronization + response packets pass through a firewall in a scenario where there are firewalls on both sides may be illustrated. As shown in FIG. 12, the TCP synchronization + response packet of the apparatus B can pass through the firewall of the apparatus A. In this case, the firewall has recorded the related connection pass-through information (that is, the aforementioned spoofed TCP synchronization packet), and the firewall knows that this connection was initiated by the apparatus A, thereby allowing the connection of the apparatus B to pass. Similarly, the TCP synchronization + response packets of the apparatus A can also pass through the firewall of the apparatus B. Therefore, the apparatus A and the apparatus B have established a connection via a relay at first, and a time delay from the apparatus A to the apparatus B is measured. Assuming that the time delay is n, after n/2 of the time passes since the apparatus A sends the TCP synchronization packet to the apparatus B, the apparatus B can also send the TCP synchronization + response packet to the apparatus A, so that when the TCP synchronization + response packet arrives at a destination, the firewall has recorded corresponding connection pass-through information, and thus, the apparatus A and the apparatus B can pass through the firewall to establish a connection.

What is claimed is:

1. A method for establishing network connections, comprising:
monitoring a controller channel by a controller;
generating a random peer ID for participating in the controller channel by a customer premise equipment (CPE);
discovering the CPE at the controller channel, displaying the CPE on a pending connection list of the controller, and determining whether the CPE should be controlled by the controller;
generating a pair of CPE's public key and CPE's private key corresponding to the CPE;
transmitting the CPE's public key, the CPE's private key, and a controller's public key corresponding to the controller via the controller channel; and
deleting the random peer ID, and using the CPE's public key obtained from the controller channel as a peer ID corresponding to the CPE.

2. The method for establishing network connections according to claim 1, wherein the random peer ID generated by the CPE is generated based on a public key cryptographic function library.

3. The method for establishing network connections according to claim 1, further comprising a discovery mechanism, wherein the discovery mechanism is a multicast domain name system (mDNS), a distributed hash table (DHT), or a direct connection upgrade through relay (DCUtR).

4. The method for establishing network connections according to claim 1, further comprising the following steps:
encrypting a connection request with the CPE's private key and the controller's public key, and connecting to the controller via a peer;
authenticating the connection request according to the controller's public key and forwarding the connection request from the CPE;
running network address translation (NAT) hole punching to authenticate the CPE's public key and returning connection information;
establishing an encrypted connection between the CPE and the controller; and
transmitting requirements and responses of a Rest API by means of the encrypted connection.

5. The method for establishing network connections according to claim 4, wherein the peer is a bootstrap peer, a relay peer, or a peer in a distributed hash table.

6. The method for establishing network connections according to claim 4, wherein the NAT hole punching uses a direct connection upgrade through relay.

7. A system for establishing network connections, comprising:
a data center, wherein the data center is provided with a firewall and a controller;
at least one local-area network, wherein each local-area network is provided with a firewall and a CPE; and
a bootstrap peer, wherein the bootstrap peer has connection information of the CPE and the controller, and establishes a connection with the CPE and the controller, respectively;
wherein the controller and the CPE establish a direct connection therebetween in an Internet by using a method for establishing network connections;
the method for establishing network connections comprises:
monitoring a controller channel by the controller;
generating a random peer ID for participating in the controller channel by the CPE;
discovering the CPE at the controller channel, displaying the CPE on a pending connection list of the controller, and determining whether the CPE should be controlled by the controller;
generating a pair of CPE's public key and CPE's private key corresponding to the CPE;
transmitting the CPE's public key, the CPE's private key, and a controller's public key corresponding to the controller via the controller channel; and
deleting the random peer ID, and using the CPE's public key obtained from the controller channel as a CPE's peer ID.

8. The system for establishing network connections according to claim 7, wherein the method for establishing network connections comprises:
encrypting a connection request with the CPE's private key and the controller's public key, and connecting to the controller via a peer;
authenticating the connection request according to the controller's public key and forwarding the connection request from the CPE;
running network address translation (NAT) hole punching to authenticate the CPE's public key and returning the connection information;
establishing an encrypted connection between the CPE and the controller; and
transmitting requirements and responses of a Rest API by means of the encrypted connection.
